(19) United States
(12) Patent Application Publication
(10) Pub. No.: US 2005/0062200 A1
(43) Pub. Date: Mar. 24, 2005

(54) Cuff-forming process

(76) Inventor: Lee John Jared, San Diego, CA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/669,844

(22) Filed: Sep. 24, 2003

(51) Int. Cl. B29C 31/00

(52) U.S. Cl. 264/295; 264/301; 264/296

(57) ABSTRACT

An adhesive band is applied by spraying, at a cuff end of a polyurethane glove, as a glove form carrying the polyurethane glove is rotated about a longitudinal axis. The adhesive band is applied before a rolled cuff is formed on the cuff end of the polymeric glove, via one or more rotating rollers or via one or more rotating brushes, as the glove form carrying the polymeric glove is rotated about the longitudinal axis. The adhesive band contains an uncured polyurethane and a solvent for the polyurethane, as contained by a bath wherein the polymeric glove was formed by dipping, withdrawing, and curing steps.

### TECHNICAL FIELD OF THE INVENTION

This invention pertains to an improved process to form a polymeric glove, such as a polyurethane glove, and to form a rolled cuff on the polymeric glove. In the improved process, an adhesive band is applied by spraying, before the rolled cuff is formed.

### BACKGROUND OF THE INVENTION

Commonly, a polymeric glove, such as a polyurethane glove, is formed in a dipping process, which may involve a single dip or successive dips. In the single dip or in a final dip of successive dips, a portion of a glove form is dipped into a bath, which contains an uncured polymer and a solvent for the polymer, so as to form a polymeric layer covering the dipped portion of the glove form or covering any polymeric layer or layers formed previously on the dipped portion of the glove form. The glove form is withdrawn, along with the covering layer and along with any polymeric layer or layers formed previously and covered by the covering layer. The covering layer is cured, along with any polymeric layer or layers formed previously, covered by the covering layer, and remaining uncured. For some polymers, such as some polyurethanes, curing may involve no more than drying the polymer under ambient conditions or under heated conditions.

As exemplified in U.S. Pat. No. 4,371,987, it is known to form a rolled cuff on a polymeric glove, as the glove form carrying the polymeric glove is rotated about a longitudinal axis, via one or more longitudinally moving, rollers rotating about a transverse axis or via one or more longitudinally moving, brushes rotating about a transverse axis. Cuff-rolling equipment of related interest is exemplified in U.S. Pat. No. 2,482,418, in U.S. Pat. No. 4,993,935, and in No. 5,909,800.

### SUMMARY OF THE INVENTION

This invention provides an improved process to form a polymeric glove, such as a polyurethane glove, and to form a rolled cuff on a cuff end of the polymeric glove. The polymeric glove is formed, as described above, by dipping a portion of a glove form into a bath, which contains an uncured polymer and a solvent for the polymer, so as to form a polymeric layer covering the dipped portion of the glove form or covering any layer or layers formed previously on the dipped portion of the glove form, by withdrawing the glove form, along with the covering layer and along with any polymeric layer or layers formed previously and covered by the covering layer, and by curing the covering layer, along with any polymeric layer or layers formed previously, covered by the covering layer, and remaining uncured, so as to form the polymeric glove.

The rolled cuff is formed on the cuff end of the polymeric glove, as described above, before the polymeric glove is stripped from the glove form. The rolled cuff may be thus formed on the cuff end of the polymeric glove, as the glove form carrying the polymeric glove is rotated about a longitudinal axis, via one or more longitudinally moving, rollers rotating about a transverse axis or via one or more longitudinally moving, brushes rotating about a transverse axis. In the improved process, however the rolled cuff is formed, an adhesive band is applied by spraying, at the cuff end of the polymeric glove, before the rolled cuff is formed. Preferably, the adhesive band contains an uncured polymer and a solvent for the uncured polymer of the adhesive band, which may be, respectively, the uncured polymer of the bath and the solvent of the bath.

### BRIEF DESCRIPTION OF THE DRAWINGS

FIGS. 1, 2, and 3 are schematic representations of successive stages in forming a rolled cuff on a cuff end of a polyurethane glove, by a preferred mode to carry out this invention.

### DETAILED DESCRIPTION OF THE ILLUSTRATED MODE

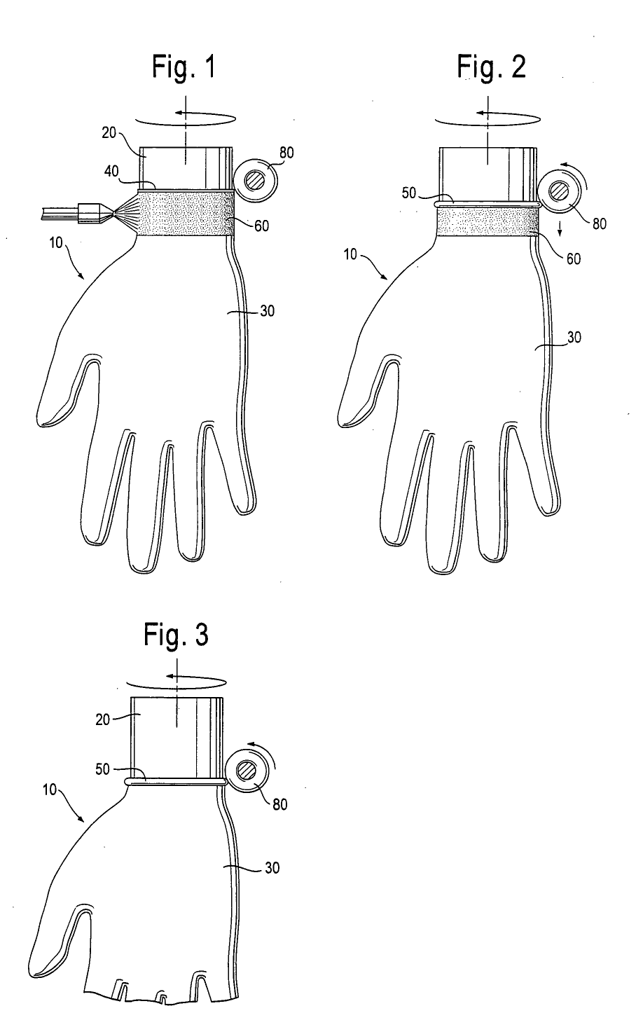

As illustrated in FIG. 1, a preferred mode to carry out this invention begins with a polymeric glove 10 that has been formed, as described above, by dipping a portion of a glove form 20 into a bath (not illustrated) containing an uncured polyurethane and containing a solvent for the polyurethane, so as to form a polyurethane layer 30 covering the dipped portion of the glove form 20 or covering any polyurethane layer or layers formed previously on the dipped portion of the glove form 20, by withdrawing the glove form 20, along with the covering layer 30 and along with any polymeric layer or layers formed previously and covered by the covering layer 30, and by curing the covering layer 30, along with any polymeric layer or layers formed previously, covered by the covering layer 30, and remaining uncured, so as to form the polymeric glove 10. The polyurethane glove 20 has a cuff end 40, at which a rolled cuff 50 is formed, before the polyurethane glove 40 is stripped from the glove form 20.

As illustrated in FIG. 1, before the rolled cuff 50 is formed, an adhesive band 60 is applied at the cuff end 40 of the polyurethane glove 10, by spraying via at least one nozzle 70, as the glove form 20 carrying the polyurethane glove 10 is rotated about a longitudinal axis, which is a vertical axis, as illustrated. As illustrated in FIGS. 2 and 3, after the adhesive band 60 has been applied, the rolled cuff 50 is formed on the cuff end 40 of the polymeric glove 10, as the glove form 20 carrying the polymeric glove 10 is rotated about the longitudinal axis, as the glove form 20 carrying the polymeric glove 10 is rotated about a longitudinal axis, via one or more longitudinally moving, rollers 80 (one illustrated) rotating about a transverse axis, which is a horizontal axis, as illustrated. After the rolled cuff 50 is formed, the adhesive band 60, which is rolled into the rolled cuff 50, is cured.

Preferably, as used in the bath and in the adhesive band, the polyurethane is a segmented polyurethane urea, which is available commercially from E.I. DuPont deNemours & Co. of Wilmington, Del., under its “D10M” trade designation or a segmented polyurethane urea, which is available commercially therefrom under its “D10M-A” trade designation, and the solvent is dimethyl acetimide or dimethyl formamide. Hence, curing involves no more than drying the polymer under ambient conditions or under heated conditions.

This invention is expected to be also effective with other polymers, with other solvents, and with other curing modes.

1. In a process to form a polymeric glove and to form a rolled cuff on a cuff end of the polymeric glove, by dipping a portion of a glove form into a bath, which contains an uncured polymer and a solvent for the polymer, so as to form a polymeric layer covering the dipped portion of the glove form or covering any polymeric layer or layers formed previously on the dipped portion of the glove form, by withdrawing the glove form, along with the covering layer and along with any polymeric layer or layers formed previously and covered by the covering layer, by curing the covering layer, along with any polymeric layer or layers formed previously, covered by the covering layer, and remaining uncured, so as to form the polymeric glove, and by forming the rolled cuff on the cuff end of the polymeric glove, as the glove form carrying the polymeric glove is rotated about a longitudinal axis, via one or more longitudinally moving, rollers rotating about a transverse axis or via one or more longitudinally moving, brushes rotating about a transverse axis, an improvement wherein an adhesive band is applied by spraying, at the cuff end of the polymeric glove, as the glove form carrying the polymeric glove is rotated about the longitudinal axis, before the rolled cuff is formed.

2. The improvement of claim 1 wherein the adhesive band contains the uncured polymer and the solvent, as contained by the bath.

3. In a process to form a polyurethane glove and to form a rolled cuff on a cuff end of the polyurethane glove, by dipping a portion of a glove form into a bath, which contains an uncured polyurethane and a solvent for the polyurethane, so as to form a polyurethane layer covering the dipped portion of the glove form or covering any polyurethane layer or layers formed previously on the dipped portion of the glove form, by withdrawing the glove form, along with the covering layer and along with any polyurethane layer or layers formed previously and covered by the covering layer, by curing the covering layer, along with any polyurethane layer or layers formed previously, covered by the covering layer, and remaining uncured, so as to form the polyurethane glove, and by forming the rolled cuff on the cuff end of the polyurethane glove, as the glove form carrying the polyurethane glove is rotated about a longitudinal axis, as the glove form carrying the polyurethane glove is rotated about a longitudinal axis, via one or more longitudinally moving, rollers rotating about a transverse axis or via one or more longitudinally moving, brushes rotating about a transverse axis, an improvement wherein an adhesive band is applied by spraying, at the cuff end of the polymeric glove, as the glove form carrying the polymeric glove is rotated about the longitudinal axis, before the rolled cuff is formed.

4. The improvement of claim 3 wherein the adhesive band contains the uncured polymer and the solvent, as contained by the bath.
